(19) United States
(12) Patent Application Publication
(10) Pub. No.: US 2008/0141063 A1
(43) Pub. Date: Jun. 12, 2008

(54) Real time elastic FIFO latency optimization

(76) Inventors: Curtis A. Ridgeway, Santa Cruz, CA (US); Ravindra Viswanath, Milpitas, CA (US); Rajinder Cheema, San Jose, CA (US)

Correspondence Address: LSI CORPORATION, 1621 BARBER LANE, MS: D-106, MILPITAS, CA, 95035, US

(21) Appl. No.: 11/637,592

(22) Filed: Dec. 12, 2006

(51) Int. Cl. G06F 1/06

(52) U.S. Cl. 713/501

(57) ABSTRACT

In some embodiments, a method for optimizing EFIFO latency may include one or more of the following steps: (a) counting each clock cycle from a read clock for a predetermined period of time, (b) counting each clock cycle from a write clock for a predetermined period of time, (c) comparing the counted read clock cycles to the write clock cycles to obtain a difference between the counted clock cycles, (d) adjusting a watermark for a queue based upon the difference between the counted clock cycles, (e) receiving a timeout signal, (f) terminating counting of the clock cycles of the read clock and write clock, and (g) initiating another optimization process after termination.

### FIELD OF THE INVENTION

Embodiments of the present invention relate to computer systems. Particularly, embodiments of the present invention relate to data buffering. More particularly, embodiments of the present invention relate to reducing and optimizing the latency of an EFIFO (elastic first in first out) queue.

### BACKGROUND OF THE INVENTION

FIFO is an acronym for First In, First Out. In computer science this term refers to the way data stored in a queue is processed. Each item in the queue is stored in a queue data structure. The first data to be added to the queue will be the first data to be removed, then processing proceeds sequentially in the same order.

FIFOs are used commonly in electronic circuits for buffering and flow control. In hardware form a FIFO primarily consists of a set of read and write pointers, storage and control logic. Storage may be SRAM, flip-flops, latches or any other suitable form of storage. An asynchronous FIFO uses different clocks for reading and writing. Asynchronous FIFOs introduce metastability issues. A conventional method for coupling devices that operate at different speeds (or asynchronously from each other) is to use a FIFO memory. To prevent an overflow condition (e.g., where incoming data is written over unread data), the distance between read and write pointers is monitored and data input stopped when the FIFO is almost full (e.g., the write pointer is within a predetermined threshold of the read pointer). An EFIFO is used in many designs to adjust between the two different clock domains running at different clock frequencies. If the frequencies are the same, the skew between the clock edges are normally known.

High speed serial protocols transmit and receive data on independent serial “lanes” with a serial transceiver at each end. The transmit data serializer is received by a deserializer at the other end where the recovered receiver clock is at the original transmitter frequency. There may be an inherent difference between the transmit clock at one end and the transmit clock at the other end (usually expressed in parts per million—ppm). An EFIFO brings the recovered data into the system clock domain, which is normally at the same frequency as the local transmitter clock. The receiver data may be lost if the EFIFO becomes full or empty.

To avoid this condition, several characters are transmitted which may be removed or inserted without effect to the data. These are referred to as skip (SKP) characters. These SKP characters can either be deleted or more SKP characters added at the receiver EFIFO depending on whether the local transmitter clock is faster or slower than the local receiver recovered clock. The EFIFO compensates for the difference between the local receiver recovered clock (write clock) and the local transmitter clock (read clock).

Conventional Elastic FIFO adjust themselves by either inserting or deleting SKP characters depending on whether they have reached their insert or delete “watermarks” (an set benchmark which determines if a SKP character is to be added or removed). When the read clock is slower than the write clock the EFIFO is written slightly faster than it is read. In this case the EFIFO will fill and when it reaches the delete water mark (Fill Watermark+1) a deletion is scheduled. When the Skip Ordered set is detected the read pointer is incremented by one in a single read clock cycle and in effect “deletes” a SKP character.

When the read clock is faster than the write clock the EFIFO is written slightly slower than it is read. In this case the EFIFO will empty and when it reaches the insert water mark (Fill Watermark−1) an insertion is scheduled. When the Skip Ordered set is detected the read pointer is frozen for a single read clock cycle and in effect “inserts” a SKP character.

The Fill Watermark is normally set to be greater than the maximum number of characters which might need to be deleted if the read clock is faster than the write clock. An additional amount of storage is added to this to account for the maximum number of characters which might need to be inserted if the read clock is slower than the write clock. The total EFIFO depth is normally about twice the fill depth, and cannot be dynamically changed based on system performance. Thus latency can be an issue if the watermark is fixed too high and data lost if it is fixed too low.

Since the read clock will be either at the same frequency as the write clock, slower than the write clock or faster than the write clock, when the read clock is slower the EFIFO fills and only the upper half of the EFIFO is used. As discussed above, the standard way to build a FIFO is to provide more storage than will really be used in any of the three cases. When the read clock is faster the EFIFO empties and only the lower half of the EFIFO is used. If the clocks are the same, the EFIFO stays at the same address and only one or two locations are used. From this we can see that only about half of the total EFIFO depth is used and the EFIFO latency is normally much more than required (same or slower read clock case). In general, the EFIFO depth is twice as what is required and the latency may be more than twice what is possible.

Therefore, it would be desirable to optimize and minimize the EFIFO latency.

### SUMMARY OF THE INVENTION

In some embodiments, a method for optimizing EFIFO latency may include one or more of the following steps: (a) counting each clock cycle from a read clock for a predetermined period of time, (b) counting each clock cycle from a write clock for a predetermined period of time, (c) comparing the counted read clock cycles to the write clock cycles to obtain a difference between the counted clock cycles, (d) adjusting a watermark for a queue based upon the difference between the counted clock cycles, (e) receiving a timeout signal, (f) terminating counting of the clock cycles of the read clock and write clock, and (g) initiating another optimization process after termination.

In some embodiments, an optimized EFIFO system may include one or more of the following features: (a) a memory comprising, (i) an optimized EFIFO program that adjusts a watermark for a queue based upon a difference between read clock cycles and write clock cycles, and (b) a processor coupled to the memory that executes the optimized EFIFO program.

In some embodiments, a machine readable medium comprising machine executable instructions may include one or more of the following features: (a) count instructions that count clock cycles from a read clock and a write clock, (b) compare instructions that compared the read clock cycles to the write clock cycles; and (c) adjust instructions that set a watermark for a queue based upon the compared value of the read clock cycles to the write clock cycles.

### BRIEF DESCRIPTION OF THE DRAWINGS

The numerous advantages of the present invention may be better understood by those skilled in the art by reference to the accompanying figures in which:

FIG. 1 shows a schematic illustration of an exemplary implementation of a computing device in an embodiment of the present invention;

FIG. 2 shows a schematic illustration of an elastic FIFO in an embodiment of the present invention;

FIG. 3 shows a flow chart diagram of an EFIFO optimization cycle in an embodiment of the present invention;

### DETAILED DESCRIPTION OF THE INVENTION

Reference will now be made in detail to the presently preferred embodiments of the invention, examples of which are illustrated in the accompanying drawings.

The following discussion is presented to enable a person skilled in the art to make and use the present teachings. Various modifications to the illustrated embodiments will be readily apparent to those skilled in the art, and the generic principles herein may be applied to other embodiments and applications without departing from the present teachings. Thus, the present teachings are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of the present teachings. Skilled artisans will recognize the examples provided herein have many useful alternatives and fall within the scope of the present teachings.

Embodiments of the present invention insert or delete a SKP character to achieve clock compensation between a read clock and a write clock. A SKP character can be inserted when a queue depth is below the watermark and deleted when the queue depth is above the watermark. However, instead of a fixed fill watermark, the watermark is dynamically changed to achieve minimum latency and to allow for the unused FIFO depth to be removed. Thus making the EFIFO more efficient.

Embodiments of the present invention provide several ways to dynamically adjust the fill watermark. This may be implemented all in logic, all in software or a mixture of the two. Embodiments of the present invention can determine if the read clock is faster, slower or the same. Once this is done, the clock difference can be used to determine the actual depth required to keep the EFIFO as empty as possible without having an underflow. One helpful criteria would be to determine if the read clock frequency is faster, slower, or the same as the write clock. Based on how much faster or slower the read clock is, the fill water mark can be picked to optimize the latency and to only require an EFIFO depth depending on the implementation requirements.

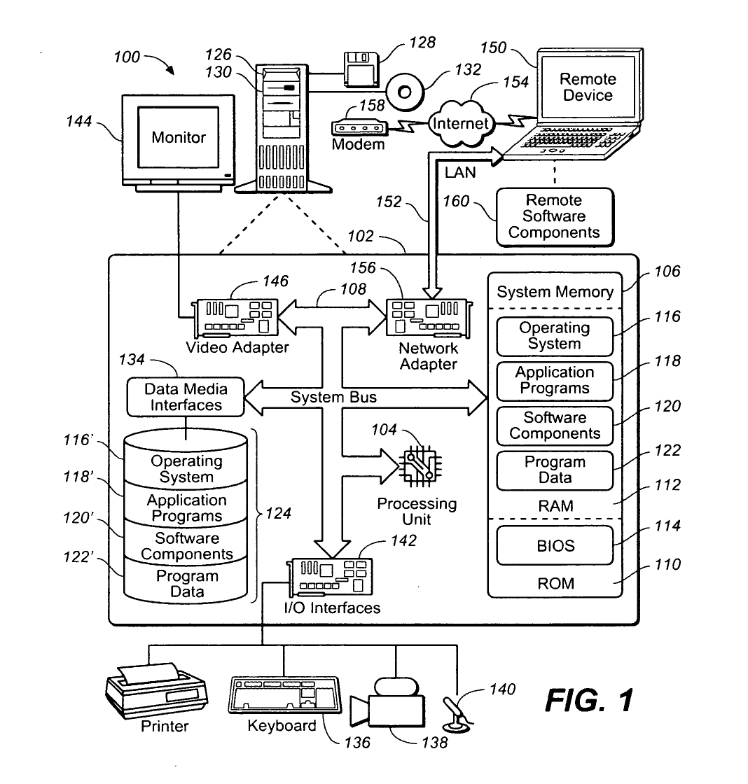

With reference to FIG. 1, a schematic illustration of an exemplary implementation of a computing device in an embodiment of the present invention is shown. The various components and functionality described herein can be implemented with a number of individual computers. FIG. 1 shows components of a typical example of such a computer, referred by to reference numeral 100. The components shown in FIG. 1 are only examples, and are not intended to suggest any limitation as to the scope of the functionality of the invention; the invention is not necessarily dependent on the features shown in FIG. 1.

Generally, various different general purpose or special purpose computing system configurations can be used. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The functionality of the computers is embodied in many cases by computer-executable instructions, such as program modules (discussed in detail below), that are executed by the computers. Generally, program modules include routines, programs, objects, components, data structures, etc. that performs particular tasks or implement particular abstract data types. Tasks might also be performed by remote processing devices that are linked through a communications network. In a distributed computing environment, program modules may be located in both local and remote computer storage media.

The instructions and/or program modules are stored at different times in the various computer-readable media that are either part of the computer or that can be read by the computer. Programs are typically distributed, for example, on floppy disks, CD-ROMs, DVD, or some form of communication media such as a modulated signal. From there, they are installed or loaded into the secondary memory of a computer. At execution, they are loaded at least partially into the computer's primary electronic memory. The invention described herein includes these and other various types of computer-readable media when such media contain instructions programs, and/or modules for implementing the steps described below in conjunction with a microprocessor or other data processors. The invention also includes the computer itself when programmed according to the methods and techniques described below.

For purposes of illustration, programs and other executable program components such as the operating system are illustrated herein as discrete blocks, although it is recognized that such programs and components reside at various times in different storage components of the computer, and are executed by the data processor(s) of the computer.

With reference to FIG. 1, the components of computer 100 may include, but are not limited to, a processing unit 104, a system memory 106, and a system bus 108 that couples various system components including the system memory to the processing unit 104. The system bus 108 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISAA) bus, Video Electronics Standards Association (VESA) local bus, and Peripheral Component Interconnect (PCI) bus also known as the Mezzanine bus.

Computer 100 typically includes a variety of computer-readable media. Computer-readable media can be any available media that can be accessed by computer 100 and includes both volatile and nonvolatile media, removable and non-removable media. By way of example, and not limitation, computer-readable media may comprise computer storage media and communication media. “Computer storage media” includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 100. Communication media typically embodies computer-readable instructions, data structures, program modules or other data in a modulated data signal such as a carrier wave or other transport mechanism and includes any information delivery media. The term “modulated data signal” means a signal that has one or more if its characteristics set or changed in such a manner as to encode information in the signal. By way of example, and not limitation, communication media includes wired media such as a wired network or direct-wired connection and wireless media such as acoustic, RF, infrared and other wireless media. Combinations of any of the above should also be included within the scope of computer readable media.

The system memory 106 includes computer storage media in the form of volatile and/or nonvolatile memory such as read only memory (ROM) 110 and random access memory (RAM) 112. A basic input/output system 114 (BIOS), containing the basic routines that help to transfer information between elements within computer 100, such as during start-up, is typically stored in ROM 110. RAM 112 typically contains data and/or program modules that are immediately accessible to and/or presently being operated on by processing unit 104. By way of example, and not limitation, FIG. 1 illustrates operating system 116, application programs 118, other program modules 120, and program data 122.

The computer 100 may also include other removable/non-removable, volatile/nonvolatile computer storage media. By way of example only, FIG. 1 illustrates a hard disk drive 124 that reads from or writes to non-removable, nonvolatile magnetic media, a magnetic disk drive 126 that reads from or writes to a removable, nonvolatile magnetic disk 128, and an optical disk drive 130 that reads from or writes to a removable, nonvolatile optical disk 132 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 124 is typically connected to the system bus 108 through a non-removable memory interface such as data media interface 134, and magnetic disk drive 126 and optical disk drive 130 are typically connected to the system bus 108 by a removable memory interface 134.

The drives and their associated computer storage media discussed above and illustrated in FIG. 1 provide storage of computer-readable instructions, data structures, program modules, and other data for computer 100. In FIG. 1, for example, hard disk drive 124 is illustrated as storing operating system 116′, application programs 118′, other program modules 120′, and program data 122′. Note that these components can either be the same as or different from operating system 116, application programs 118, other program modules 120, and program data 122. Operating system 116, application programs 118, other program modules 120, and program data 122 are given different numbers here to illustrate that, at a minimum, they are different copies. A user may enter commands and information into the computer 100 through input devices such as a keyboard 136, a mouse, trackball, or touch pad. Other input devices (not shown) may include a microphone, joystick, game pad, satellite dish, scanner, or the like. These and other input devices are often connected to the processing unit 104 through an input/output (I/O) interface 142 that is coupled to the system bus, but may be connected by other interface and bus structures, such as a parallel port, game port, or a universal serial bus (USB). A monitor 144 or other type of display device is also connected to the system bus 108 via an interface, such as a video adapter 146. In addition to the monitor 144, computers may also include other peripheral output devices (e.g., speakers) and one or more printers, which may be connected through the I/O interface 142.

The computer may operate in a networked environment using logical connections to one or more remote computers, such as a remote computing device 150. The remote computing device 150 may be a personal computer, a server, a router, a network PC, a peer device or other common network node, and typically includes many or all of the elements described above relative to computer 100. The logical connections depicted in FIG. 1 include a local area network (LAN) 152 and a wide area network (WAN) 154. Although WAN 154 shown in FIG. 1 is the Internet, WAN 154 may also include other networks. Such networking environments are commonplace in offices, enterprise-wide computer networks, intranets, and the like.

When used in a LAN networking environment, the computer 100 is connected to the LAN 152 through a network interface or adapter 156. When used in a WAN networking environment, the computer 100 typically includes a modem 158 or other means for establishing communications over the Internet 154. The modem 158, which may be internal or external, may be connected to the system bus 108 via the I/O interface 142, or other appropriate mechanism. In a networked environment, program modules depicted relative to the computer 100, or portions thereof, may be stored in the remote computing device 150. By way of example, and not limitation, FIG. 1 illustrates remote application programs 160 as residing on remote computing device 150. It will be appreciated that the network connections shown are exemplary and other means of establishing a communications link between the computers may be used.

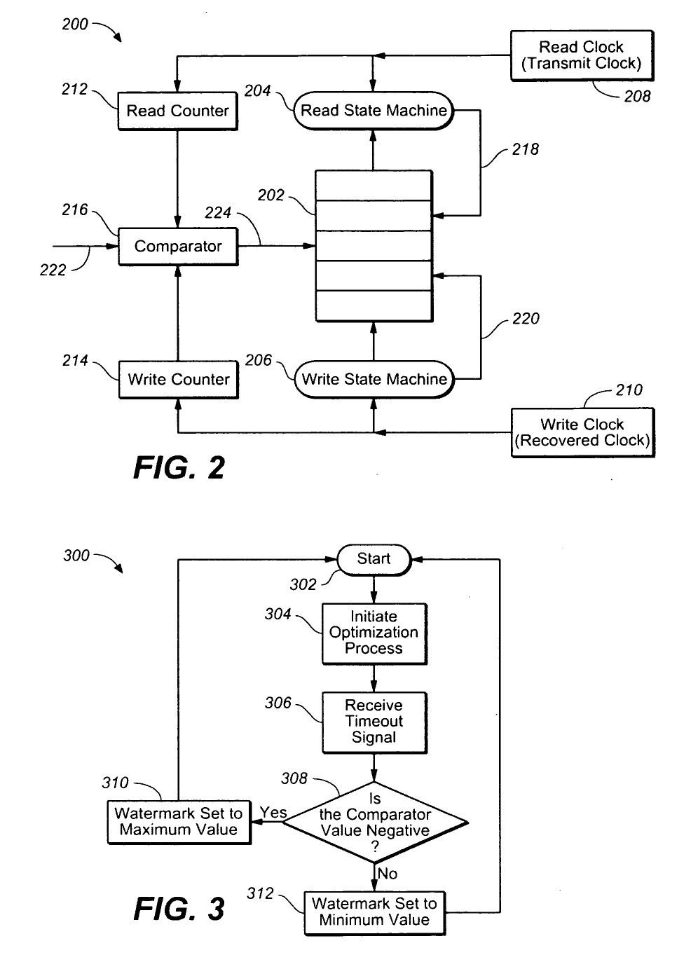

With reference to FIG. 2, a schematic illustration of an elastic FIFO in an embodiment of the present invention is shown. Elastic FIFO 200 could be implemented in hardware, software or both without departing from the spirit of the invention. For purposes of this disclosure, EFIFO 200 is shown in an upper level box diagram for purposes of illustration and to show it could be implemented through hardware, software, or both. EFIFO could be implemented in hardware if the clock speed is faster than a local processor. Counting the difference between the clocks can be done in hardware. The calculation of where the insert or delete watermark is to be set can be done in hardware or software if a local processor is present. It would be helpful to have it performed in hardware to save logic processing time and for lower complexity. EFIFO can have a queue 202, read state machine 204, write state machine 206, read clock 208, write clock 210, read counter 212, write counter 214, and a comparator 216.

Queue 202 can be located in system memory 106. However queue 202 could also be located in RAM 112, ROM 110, or removable memory 134 without departing from the spirit of the invention. It is fully contemplated that queue 202 could be located in any electronic device where data crosses from one clock domain into another and either the latency is an issue or the amount of storage is an issue without departing from the spirit of the invention. Queue 202 can be coupled to read state machine 204 and write state machine 206 by system bus 108. Read state machine 204 copies data from queue 202 to be used by applications. Read state machine 204 has a pointer 218 that contains an address in queue 202 to which pointer 218 is assigned. Read state machine is also coupled to read clock 208 that dictates how often read state machine 204 performs a read function. Queue 202 can be coupled to a write state machine 206 that writes data to queue 202 for use by applications. Write state machine 206 has a pointer 220 that contains an address in queue 202 to which pointer 220 is assigned. Write state machine 206 is coupled to write clock 210 which determines at what rate write state machine 206 writes information to queue 202. As stated before, read clock 208 and write clock 210 may not be clocking at the same frequency. Most manufactures will try to get the difference between the clocking rates to be minimal (e.g., a low ppm). However, matching the clocks is very difficult and usually results in the selection of expensive precise clocks.

Read clock 208 and read state machine 204 are coupled to read counter 212. Read counter 212 is a counter that increments each time read clock 208 cycles. Write clock 208 and write state machine 206 are coupled to write counter 214. Write counter 214 is a counter that increments each time write clock 210 cycles. Read counter 212 and write counter 214 input their values to comparator 216. Comparator 216 keeps a dynamic value of the difference between the number of clock cycles provided by read counter 212 and write counter 214. This will be described in more detail below. At a predetermined time a timeout signal 222 will arrive at comparator 216 which informs comparator 216 to stop calculating the difference between the value supplied by read counter 212 and write counter 214. The value contained in comparator 216 at that time is used to set fill watermark 224. This will be described in more detail below.

An embodiment to determine the frequency difference could be to measure how the difference between the number of characters written by write clock 210 and the number read by read clock 208 over a predetermined time interval based upon system characteristics, such as a controlling specification, e.g., the PCI-Express. During this calibration time, EFIFO 200 may be operating in a conventional way or disabled, such as the EFIFO 200 output being ignored

With reference to FIG. 3 a flow chart diagram of an EFIFO optimization cycle in an embodiment of the present invention is shown. Optimization application 300 begins at state 302 where comparator 216 is reset to zero by application 300. At state 304 application 300 begins the optimization process by instructing comparator 216 to begin tracking the difference between the read clock cycles and write clock cycles. After a predetermined time (e.g., 7000 to make the calculation easy and accurate) application 300 sends timeout signal 222 which causes comparator 216 to stop calculating the difference between clocking cycles at state 306. If the optimization interval (predetermined time interval) is equal to the worst case maximum number of characters between skip ordered sets, the difference will be the required EFIFO depth as is discussed in more detail below. Application 300 determines if the comparator value is negative (e.g., the read counter value minus the write counter value is negative) at state 308. If the value is negative, then queue 202 will become empty. Therefore, watermark 224 should be set to the maximum value of one at state 310. If the comparator value is not negative, application 300 then proceeds to state 312. Since the comparator value is not negative, then it. is either positive (e.g., the read counter value minus the write counter value is positive) or zero. This means queue 202 will become full and therefore watermark 224 should be the minimum valve of one at state 312. Further fine tuning can be done by adjusting fill watermark 224 down if queue 202 ever reaches an overflow condition or adjust it upward if queue 202 ever reaches an underflow condition. After reaching state 310 or 312, application 300 returns to state 302.

Application 300 could be executed by processing unit 104 as described above. Application 300 could be stored in system memory 106 or in removable memory interface 134. Application 300 could be set to be only executed once, such as upon initial power on of the computer 100, executed at predetermined intervals, such as every several seconds or minutes, or executed continuously. The decision on how often to execute application 300 could be made based upon the types of clocks used for read clock 208 and write clock 210. For example, if the clocks are very reliable and accurate, such having the same time base or are very close in frequency, then application 300 could be run only once at power on of the computer 100. If the clocks are less reliable and less accurate, such as having different time bases or varying in frequency, then application 300 could be run periodically or continuously. Application 300 could let the manufacture of computer 100 to choose a less reliable and thus less expensive read 208 and write clock 210 knowing that application 300 will reliably and accurately set watermark 224 for optimum and efficient use of queue 202 at a decreased expense. Application 300 could also allow the manufacture to use clocks which may degrade over time knowing that a periodically run application 300 would keep queue 202 running efficiently.

To more clearly point out the operation of embodiments of the present invention the following examples are provided. PCI-Express, is an implementation of the PCI computer bus that uses existing PCI programming concepts, but bases it on a completely different and much faster serial physical-layer communications protocol. PCI-Express is used for the purpose of the examples below. In use of PCI-Express, the worst case maximum interval between skip ordered sets is 5662 characters. Skip ordered sets are scheduled a minimum of every 1180 characters and a maximum of 1538 characters. The worst case frequency difference will result in a one character change every 1666 characters. In this implementation, if a skip ordered set can not be sent because of a long data frame, they will be sent back-to-back after the data frame. This means after a maximum of 5662 characters, (5662/1538) 3.6 skip ordered sets are sent back-to-back. The minimum queue depth is about (5662/1666) 3.4. This value may need to be modified depending on the uncertainty within the actual queue implementation. A designer normally can calculate how accurate the implementation is. They can add a “margin for error” into the design which is the uncertainty within the queue. PCI-Express provides a “training sequence” to allow read state machine and the write state machine to establish communications. The minimum time after power-on is 20 msec to start with about 24 msec to complete the “training sequence”. The transmit and receiver PLL's (phased lock loops) normally take about 30 μsec to get up to speed, therefore there is plenty of time to calibrate EFIFO 200.

In the following three scenarios the programmable interval is assumed to be (1666×4) 6664 and to keep it simple an even number, 7000, will be used. In the first example, the read count is 7000 and the write count is 6696. Thus subtracting the write count from the read count the difference is +4. Therefore, in the first example EFIFO 200 will empty. Thus fill watermark 224 can be set to four to insure EFIFO 200 doesn't empty and thus the queue depth should be at least four to support watermark 224.

In the second example, the read count is 7000 and the write count is 7004. Thus the difference is −4. Thus EFIFO 200 will fill. Therefore, fill watermark 224 should be set to one since that is the maximum it can be set to and the queue depth should be at least five to allow for some margin for error.

In the third example, the read count is 7000 and the write count is 7001. The difference is −1. Therefore, EFIFO 200 will remain the same. Fill watermark 224 will remain at one since that is the maximum it can be and the depth should be at least two to allow for margin.

Based on these examples, an EFIFO depth of five or more would be reliable for most any real world case. The implementation depends on the uncertainties of the design on how close the actual values are to the calculated values. The EFIFO depth and fill watermarks can be adjusted during the design process to account for all cases.

It is believed that the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. Features of any of the variously described embodiments may be used in other embodiments. The form herein before described being merely an explanatory embodiment thereof. It is the intention of the following claims to encompass and include such changes.

What is claimed is:

1. A method for optimizing EFIFO latency, comprising the steps of:
counting each clock cycle from a read clock for a predetermined period of time;
counting each clock cycle from a write clock for a predetermined period of time;
comparing the counted read clock cycles to the write clock cycles to obtain a difference between the counted clock cycles; and
adjusting a watermark for a queue based upon the difference between the counted clock cycles.

2. The method of claim 1, wherein the difference between the counted clock cycles is obtained by subtracting the write clock cycles from the read clock cycles.

3. The method of claim 2, wherein the watermark is set to a maximum value if the difference between the counted clock cycles is negative.

4. The method of claim 2, wherein the watermark is set to a minimum value if the difference between the counted clock cycles zero or greater.

5. The method of claim 1, further comprising the step of receiving a timeout signal.

6. The method of claim 5, further comprising terminating counting of the clock cycles of the read clock and write clock.

7. The method of claim 6, further comprising initiating another optimization process after termination.

8. A optimized EFIFO system comprising:
a memory comprising:
an optimized EFIFO program that adjusts a watermark for a queue based upon a difference between read clock cycles and write clock cycles; and
a processor coupled to the memory that executes the optimized EFIFO program.

9. The system of claim 8, wherein the program counts read clock cycles.

10. The system of claim 9, wherein the program counts write clock cycles.

11. The system of claim 10, wherein the difference is calculated by subtracting the write clock cycles from the read clock cycles.

12. The system of claim 11, wherein the watermark is set to a maximum value if the difference is negative.

13. The system of claim 12, wherein the watermark is set to a minimum value if the difference is zero or above.

14. A machine readable medium comprising machine executable instructions, including:
count instructions that count clock cycles from a read clock and a write clock;
compare instructions that compared the read clock cycles to the write clock cycles; and
adjust instructions that set a watermark for a queue based upon the compared value of the read clock cycles to the write clock cycles.

15. The medium of claim 14, wherein the compare instructions obtain the difference of the write clock cycles subtracted from the read clock cycles.

16. The medium of claim 15, wherein the adjust instructions set the watermark to a maximum value if the difference is a negative value.

17. The medium of claim 16, wherein the adjust instructions set the watermark to a minimum value if the difference is zero or greater value.

18. The medium of claim 14, wherein the count instructions are terminated by a timeout signal.

19. The medium of claim 16, wherein the maximum value is determined by the negative value.

20. The medium of claim 18, wherein the count instructions are initiated again after termination.
